(19) United States
(12) Patent Application Publication
(10) Pub. No.: US 2023/0244472 A1
(43) Pub. Date: Aug. 3, 2023

(54) Configuration Device, Update Server and Method for Updating Software of a Technical Installation

(71) Applicant: Siemens Aktiengesellschaft, München (DE)

(72) Inventors: Armin Amrhein, Kümmersbruck (DE); Stefan Becker, Adelsdorf (DE); Rainer Falk, Poing (DE); Axel Pfau, Freiburg (DE)

(73) Assignee: Siemens Aktiengesellschaft, München (DE)

(21) Appl. No.: 18/008,238

(22) PCT Filed: Jun. 7, 2021
(86) PCT No.: PCT/EP2021/065132

§ 371 Date: Dec. 5, 2022

(30) Foreign Application Priority Data
Jun. 8, 2020 (EP) 20178794.2

(51) Int. Cl. G06F 8/65

(52) U.S. Cl. CPC G06F 8/65

(57) ABSTRACT

Various embodiments of the teachings herein include a configuration device for determining an update configuration for a software update for a technical installation. The device may include: a module to acquire operating parameters of a production process of a technical installation, including configuration parameters of the technical installation; a module to load software updates for one or more elements of the technical installation; a module to use the operating parameters and the software updates as a basis for determining an update configuration for the software updates; and a module to transfer the update configuration and/or the software updates to an update server. The update server controls and/or monitors and/or records the software update of the one or more elements of the technical installation on the basis of the update configuration.

### CROSS-REFERENCE TO RELATED APPLICATIONS

This application is a U.S. National Stage Application of International Application No. PCT/EP2021/065132 filed Jun. 7, 2021, which designates the United States of America, and claims priority to EP Application No. 20178794.2 filed Jun. 8, 2020, the contents of which are hereby incorporated by reference in their entirety.

### BACKGROUND

The present disclosure relates to technical installations. Various embodiments of the teachings herein include configuration devices, update servers, and/or methods for updating software of a technical installation.

### SUMMARY

Some embodiments of the teachings herein include a configuration device for determining an update configuration for a software update for a technical installation, comprising: an acquisition module, wherein the acquisition module is configured to acquire operating parameters of a production process of a technical installation, the operating parameters comprise configuration parameters of the technical installation, a loading module, wherein the loading module is configured to load software updates for one or more elements of the technical installation; a determination module, wherein the determination module is configured to take the operating parameters and the software updates as a basis for determining an update configuration for the software updates of the one or more elements of the technical installation, a provisioning module, wherein the provisioning module is configured to transfer the update configuration and/or the software updates to an update server, wherein the update server controls and/or monitors and/or records the software update of the one or more elements of the technical installation on the basis of the update configuration.

In some embodiments, the operating parameters of the production process of the technical installation are assessed by an assessment module, wherein the operating parameters comprise the assessment of the assessment module and wherein the determination module is configured to optimize the update configuration on the basis of the operating parameters and the software updates of the one or more elements of the technical installation and wherein the determination module is configured to optimize the update configuration on the basis of the operating parameters and the software updates of the one or more elements of the technical installation.

In some embodiments, the determining of the update configuration determines operating specifications and wherein the operating specifications are specifications that need to be observed by the technical installation and/or by applicable elements of the technical installation during and/or after the performance of the software update.

In some embodiments, the determining of the update configuration takes into consideration an update duration for applicable elements of the technical installation, and/or the determining of the update configuration takes into consideration a rollback time to a state before the software update of the applicable elements of the technical installation, and/or the determining of the update configuration checks whether a restart for the applicable elements of the technical installation is necessary or whether a live update for the technical installation is possible, and/or the determining of the update configuration determines what effects the software update has on the technical installation and/or applicable elements of the technical installation during the software update and/or after the software update, and/or the determining of the update configuration takes into consideration an expected temperature increase for one or more processors of the technical installation and/or for applicable elements of the technical installation, and/or the determining of the update configuration takes into consideration the required storage space and processor power for the software update, and/or the determining of the update configuration takes into consideration a software compatibility with the existing software and the software update, and/or the determining of the update configuration takes into consideration license requirements, and/or the determining of the update configuration takes into consideration an effect on the technical installation in the event of a software update for multiple elements of the technical installation, and/or the determining of the update configuration takes into consideration a compatibility between updated and unupdated elements of the technical installation, and/or the determining of the update configuration takes into consideration whether the software update is performable automatically or a manual intervention is required, and/or the determining of the update configuration takes into consideration necessary access rights, and/or the determining of the update configuration takes into consideration whether an automated check on manually performed steps is performable, and/or the determining of the update configuration takes into consideration whether the software update for an applicable element indicates how said element needs to be installed, and/or the determining of the update configuration may involve empirical values from updates performed earlier and may implement said empirical values in the form of improvements.

In some embodiments, the performance of the software update of the technical installation is simulated in order to determine the effects of the performance of the software update on the technical installation by way of a simulation.

In some embodiments, the simulation additionally simulates effects of the performance of the software update on the production process, and/or the simulation additionally simulates effects of the software update on the production process.

As another example, some embodiments include an update server for controlling a software update for a technical installation, comprising: a receiving module, wherein the receiving module is configured to receive an update configuration and/or a software update, the update configuration and/or the software update is received from a configuration device as described herein; an update control system, wherein the update control system is configured to perform a software update for a technical installation and/or an element or for multiple elements of the technical installation on the basis of the update configuration, the update configuration comprises operating specifications that need to be observed by the technical installation and/or by the applicable elements of the technical installation during and/or after the performance of the software update.

In some embodiments, the update configuration is an update configuration as described herein.

In some embodiments, the update server comprises a monitoring module, the monitoring module is configured to acquire operating parameters of the technical installation and/or of the applicable elements of the technical installation during the performance of the software update, the monitoring module is configured to determine a check result on the basis of the operating specifications and the operating parameters, a further performance of the software update is controlled on the basis of the check result, an alarm is triggered and/or the software update is terminated if the operating specifications are exceeded by the operating parameters, the software update is continued if the operating specifications are observed by the operating parameters.

In some embodiments, the update server comprises a key memory for access data and/or license data and/or key material, such as in particular cryptographic keys, the update server uses the applicable key material and/or the applicable access data and/or the applicable license data for the software update of the technical installation or of an applicable element of the technical installation, the update server uses the key material in order to digitally sign a recorded history of the software update, the key material and/or the access data and/or the license data are assigned specifically to applicable elements of the technical installation and/or are assigned specifically to applicable parts of the software update of applicable elements.

In some embodiments, the software update comprises one or more package elements for the software update, applicable package elements are assigned specifically for the software update of applicable elements of the technical installation, the applicable package elements are provided by different sources, the package elements are stored as a bundle in the software update by the update server and/or the configuration device.

In some embodiments, the update server comprises an interface for secure communication with the applicable elements of the technical installation.

As another example, some embodiments include a computer-implemented method for determining an update configuration for a software update for a technical installation, comprising the following method steps: acquiring operating parameters of a production process of a technical installation, wherein the operating parameters comprise configuration parameters of the technical installation, the operating parameters of the production process of the technical installation are assessed by an assessment module, the operating parameters comprise the assessment of the assessment module; loading a software update for one or more elements of the technical installation; determining an update configuration on the basis of the operating parameters and the software updates for the software updates of the one or more elements of the technical installation, wherein the update configuration is preferably optimized on the basis of the operating parameters and the software updates of the one or more elements of the technical installation; transferring the update configuration and/or the software update to an update server, wherein the update server controls and/or monitors and/or records the software update of the one or more elements of the technical installation on the basis of the update configuration.

As another example, some embodiments include a computer-implemented method for controlling a software update, comprising the following method steps: receiving an update configuration and/or a software update, wherein the update configuration and/or the software update is received from a configuration device as described herein; performing a software update for a technical installation and/or one or more elements of the technical installation on the basis of the update configuration, wherein the update configuration comprises operating specifications that need to be observed by the technical installation and/or by the applicable elements of the technical installation during and/or after the performance of the software update.

As another example, some embodiments include a computer program product having program commands for performing one or more of the methods as described herein.

As another example, some embodiments include a provisioning device for the computer program product as described herein, wherein the provisioning device stores and/or provides the computer program product, the computer program product is cryptographically protected, by way of example, the cryptographic protection is a digital signature and/or an encryption of the computer program product and/or is a cryptographic checksum, the cryptographic protection may be checked and/or removed by means of the key material of the update server.

### BRIEF DESCRIPTION OF THE DRAWINGS

The properties, features, and advantages of the teachings of the present disclosure that are described above and the way in which they are attained will become clearer and more distinctly comprehensible in conjunction with the description of the exemplary embodiments that follows, said exemplary embodiments being explained more thoroughly in conjunction with the figures, in which, in schematic representations:

FIG. 1 shows a first exemplary embodiment incorporating teachings of the present disclosure;

FIG. 2 shows a further exemplary embodiment incorporating teachings of the present disclosure;

FIG. 3 shows a further exemplary embodiment incorporating teachings of the present disclosure.

### DETAILED DESCRIPTION

The teachings of the present disclosure describe a configuration device for determining an update configuration for a software update for a technical installation, comprising: an acquisition module, wherein the acquisition module is configured to acquire operating parameters of a production process of a technical installation, the operating parameters comprise configuration parameters of the technical installation, the operating parameters of the production process of the technical installation are assessed by an assessment module, the operating parameters comprise the assessment of the assessment module; a loading module, wherein the loading module is configured to load software updates for one or more elements of the technical installation; a determination module, wherein the determination module is configured to take the operating parameters and the software updates as a basis for determining an update configuration for the software updates of the one or more elements of the technical installation, the determination module is configured to optimize the update configuration on the basis of the operating parameters and the software updates of the one or more elements of the technical installation; a provisioning module, wherein the provisioning module is configured to transfer the update configuration and/or the software updates to an update server, wherein the update server controls and/or monitors and/or records the software update of the one or more elements of the technical installation on the basis of the update configuration.

Unless the description below indicates otherwise, the terms “perform”, “calculate”, “computer-aided”, “compute”, “establish”, “generate”, “configure”, “reconstruct” and the like generally refer to actions and/or processes and/or processing steps which modify and/or generate data and/or convert the data into other data, wherein the data are represented or may occur in particular as physical quantities, e.g. as electrical pulses. In particular, the expression “computer” should be interpreted as broadly as possible in order to cover in particular all electronic devices with data processing characteristics.

Computers may therefore include personal computers, servers, programmable logic controllers (PLCs), handheld computer systems, pocket PC devices, mobile radios and other communication devices which can process data in a computer-aided manner, processors and other electronic data processing devices.

“Computer-aided” means an implementation of the method in which in particular a processor carries out at least one method step of the method. “Computer-aided” is also intended to be understood to mean “computer-implemented”.

A processor or programmable processor means a machine or an electronic circuit. A processor may in particular be a central processing unit (CPU), a microprocessor or a microcontroller, preferably an application-specific integrated circuit or a digital signal processor, possibly in combination with a storage unit for storing program commands, etc. A processor may also be an IC (Integrated Circuit), in particular an FPGA (Field Programmable Gate Array) or an ASIC (Application-Specific Integrated Circuit), or a DSP (Digital Signal Processor) or a GPU (Graphics Processing Unit). A processor means a virtualized processor, a virtual machine or a soft CPU. It may in particular also be a programmable processor which is equipped with configuration steps to carry out said methods or is configured with configuration steps in such a way that the programmable processor implements the features of the method, the component, the modules or other aspects and/or partial aspects of the teachings herein.

A “module” means a circuit of a processor and/or a memory of the processor for storing program commands. In particular, the circuit is specifically configured to execute the program commands in such a way that the processor performs functions in order to implement or carry out one or more of the methods described herein.

“Comprise”, “have” and the like, in particular in relation to data and/or information, means a (computer-aided) storage of applicable information, or of an applicable datum, in a data structure/dataset (which is in turn stored in a memory).

Within the context of this disclosure, “unupdated” means in particular that an applicable element of the technical installation has a software status (e.g. software version, patch status) that differs from the software status of the software update. It may be the case that individual elements (in particular devices) of the technical installation cannot be updated because there is no suitable software update (in particular patch) available for them or they cannot be updated for reasons of connectivity or reasons of compatibility with a device connected to them. It is in particular also conceivable for the technical installation to comprise similar or physically identical elements, but for some of these to be unupdated, since these unupdated elements are unsuitable for a software update due to compatibility requirements.

“Software update” means a software package that comprises one or more further software updates or software packages. A software package may also be a firmware update or comprise a firmware update. The applicable software updates are used to update the software or software components of the technical installation. To this end, in particular the applicable software packages are used in accordance with the update configuration to update the software or software components of the technical installation or of the elements of the technical installation. A software update may result in existing software modules being replaced with an updated version. However, it is also possible for a software update to result in an additional software module being added to a software configuration. The elements of the technical installation may appropriately be devices and/or control systems and/or software components and/or production machines and/or field devices.

Using the update configuration (appropriately also called the patch plan) to significantly improve the planning, automation, or performance of an automation, monitoring and recording of the software update (in particular also called patching or patching measures) of the technical installation (preferably an industrial installation) and the elements thereof (in particular individual devices, critical installation parts) compared to software update methods used in technical installations today. In particular highly complex technical installations connected to the update server using a clever concept for linking the elements benefit considerably from the update configuration in the points of user-friendliness, time saving and cost saving.

Restrictions or interruptions in the production process may be avoided or reduced. This allows in particular production downtime or an impaired quality of the finished goods to be avoided. Furthermore, it allows patching, in particular installation of security updates, to be performed promptly, since adverse effects of patching on an ongoing production process are avoided or at least reduced. Furthermore, it is possible to reduce the effect on one or more key performance indicators (KPI) of a production installation. Examples are the utilization level of a production installation or the amount of goods produced.

The optimization may be used in particular to minimize the susceptibility of the technical installation to error during the software update, or sequences may be carried out in a more optimum manner (in particular the software update for individual elements). Moreover, a continuous iterative software update (patching) for the technical installation allows the installation to prepare itself for changing requirements in order to be appropriately tailored to specific production changes.

The update configuration and the update server are preferably used to achieve an improved and automated software update in industrial installations. The update configuration results in a detailed overview of tasks, opportunities, restrictions and constraints for the software update process in industrial installations and/or technical installations. The update server offers support for the automated software update and for the secure recording of the software update status.

The software update may be able to look at both the applicable individual elements (in particular individual devices) and the technical installation as a whole. In some cases, e.g. uncritical software update processes may take place in a fully automated manner, in particular during the interaction between the device that needs to be patched and the update server. Software update processes may in particular be uncritical if the performance thereof has no or only insignificant effects on a production process or on key performance indicators of a production process. However, the software update may appropriately nevertheless be a software update that is important from a security standpoint, since it heals a critical vulnerability. Recordings of the overall software update status of a technical installation are possible. The recordings may appropriately be provided in a manner protected against tampering. The recordings may be provided to an asset management system in the applicable technical installation.

In some embodiments, the determining of the update configuration determines operating specifications, wherein the operating specifications are specifications that need to be observed by the technical installation and/or by applicable elements of the technical installation during and/or after the performance of the software update. Operating specifications may be in particular downtimes of elements (in particular devices and/or software components) of the technical installation, update times of elements or operating states (in particular processor temperature and/or memory utilization level and/or usability of the element despite ongoing software update) of elements.

The operating specifications may also specify that restarts are necessary or prohibited, and/or a maximum number of restarts may be specified and/or the time requirement may be specified or how long successful performance of a software update is permitted to take. Operating specifications may also relate to key performance indicators of the technical installation that are determined on the basis of the actual operation of the technical installation, in particular by determining production data and by calculating derived key performance indicators. The operating specifications may also be a combination of one or more of said possibilities.

In some embodiments, the following data are additionally taken into consideration:
the determining of the update configuration takes into consideration an update duration for applicable elements of the technical installation, and/or
the determining of the update configuration takes into consideration a rollback time to a state before the software update of the applicable elements of the technical installation, and/or
the determining of the update configuration checks whether a restart for the applicable elements of the technical installation is necessary, or whether a live update for the technical installation is possible, and/or
the determining of the update configuration determines what effects the software update has on the technical installation and/or applicable elements of the technical installation during the software update and/or after the software update, and/or
the determining of the update configuration takes into consideration an expected temperature increase for one or more processors of the technical installation and/or for applicable elements of the technical installation, and/or
the determining of the update configuration takes into consideration the required storage space and the required processor power for the software update, and/or
the determining of the update configuration takes into consideration a software compatibility with the existing software and the software update, and/or
the determining of the update configuration takes into consideration license requirements, and/or
the determining of the update configuration takes into consideration an effect on the technical installation in the event of a software update for multiple elements of the technical installation, and/or
the determining of the update configuration takes into consideration a compatibility between updated and unupdated elements of the technical installation, and/or
the determining of the update configuration takes into consideration whether the software update is performable automatically, or a manual intervention is required, and/or
the determining of the update configuration takes into consideration necessary access rights, and/or
the determining of the update configuration takes into consideration whether an automated check on manually performed steps is performable, and/or
the determining of the update configuration takes into consideration whether the software update for an applicable element indicates how said element needs to be installed (appropriately, is local installation possible or can this also take place remotely, in particular using remote maintenance software), and/or
the determining of the update configuration may involve empirical values from updates performed earlier and may implement said empirical values in the form of improvements.

The empirical values may be used in particular to continually improve the software update for the technical installation or other physically identical technical installations by taking into consideration the empirical values from previous/earlier software updates.

In some embodiments, the performance of the software update and the effects thereof on the technical installation are determined by way of a simulation. The existing software may preferably be the firmware of applicable elements of the technical installation or software components of the applicable elements. The software components may appropriately be the installed operating system and/or the version of the installed operating system and/or the patch status of the installed operating system and/or the installed drivers and/or the patch status of the installed drivers. The software components may in particular also be software introduced by the user, such as, appropriately, the configuration of a PLC or an app on an edge device.

In some embodiments, the performance of the software update of the technical installation is simulated in order to determine the effects of the performance of the software update on the technical installation by way of a simulation. The simulation here relates to how the technical installation or how selected or critical parts (e.g. specific elements) of the technical installation behave(s) during and after the software update. This may be useful for carrying out a software update during ongoing operation of the technical installation.

In some embodiments, the effects may be displayed to a user (in particular for manual approval decisions regarding the update configuration being admissible, or for automatic approval decisions). The software update is installed only after approval has been given. The immediate effects may be displayed to a user. Similarly, it is possible for effects on derived information such as in particular key performance indicators to be determined and displayed to a user.

This may be repeated for different operating states of the technical installation, in order in particular to determine a suitable time for update.

In some embodiments, an update server for controlling a software update of the technical installation comprises:
a receiving module, wherein
   the receiving module is configured to receive an update configuration and/or a software update,
   the update configuration and/or the software update is received from a configuration device as described herein;
an update control system, wherein
   the update control system is configured to perform a software update for a technical installation and/or an element or for multiple elements of the technical installation on the basis of the update configuration,
   the update configuration preferably comprises operating specifications that need to be observed by the technical installation and/or by the applicable elements of the technical installation during and/or after the performance of the software update.

In some embodiments, the update configuration is an applicable update configuration of the configuration device incorporating teachings of the present disclosure.

In some embodiments, the update server comprises a monitoring module, wherein
the monitoring module is configured to acquire operating parameters of the technical installation and/or of the applicable elements of the technical installation during the performance of the software update,
the monitoring module is configured to determine a check result on the basis of the operating specifications and the operating parameters,
a further performance of the software update is controlled on the basis of the check result,
in some embodiments, an alarm is triggered and/or the software update is terminated if the operating specifications are exceeded by the operating parameters,
in some embodiments, the software update is continued if the operating specifications are observed by the operating parameters.

In some embodiments, the update server comprises a key memory for cryptographic keys and/or access data and/or license data, wherein
the update server uses the applicable key material and/or the applicable access data and/or the applicable license data for the software update of the technical installation or of an applicable element of the technical installation,
the update server uses the key material in order to digitally sign a recorded history of the software update,
in some embodiments, the key material and/or the access data and/or the license data are assigned specifically to applicable elements of the technical installation and/or are assigned specifically to applicable parts of the software update of applicable elements.

The digital signing may take into consideration a date and a time (in particular a current/just recorded date/time).

The key material (in particular cryptographic key, digital certificates) may also be used to communicate securely with the instances (e.g. different update servers of the applicable manufacturers/suppliers or a cloud application) that provide the applicable software update.

In some embodiments, the software update comprises one or more package elements for the software update, wherein
in some embodiments, applicable package elements are assigned specifically for the software update of applicable elements of the technical installation,
in some embodiments, the applicable package elements are provided by different sources,
in some embodiments, the package elements are stored as a bundle in the software update by the update server and/or the configuration device.

The sources may be update servers, in particular of various manufacturers and/or suppliers of the applicable elements of the technical installation.

In some embodiments, the update server comprises an interface (in particular a web interface) for secure communication with the applicable elements of the technical installation.

In some embodiments, a computer-implemented method for determining an update configuration for a software update for a technical installation, comprises the following:
acquiring operating parameters of a production process of a technical installation, wherein
   the operating parameters comprise configuration parameters of the technical installation,
   in some embodiments, the operating parameters of the production process of the technical installation are assessed by an assessment module,
   in some embodiments, the operating parameters comprise the assessment of the assessment module;
loading a software update for one or more elements of the technical installation;
determining an update configuration on the basis of the operating parameters and the software updates for the software updates of the one or more elements of the technical installation, wherein in some embodiments, the update configuration is optimized on the basis of the operating parameters and the software updates of the one or more elements of the technical installation;
transferring the update configuration and/or the software update to an update server, wherein the update server controls and/or monitors and/or records the software update of the one or more elements of the technical installation on the basis of the update configuration.

In some embodiments, the method comprises further method steps or features in order to implement the functional features of the configuration device or in order to implement further features of the configuration device, or the embodiments thereof.

In some embodiments, the disclosure relates to a computer-implemented method for controlling a software update, comprising the following:
receiving an update configuration and/or a software update, wherein
   the update configuration and/or the software update is preferably received from a configuration device as described herein;
performing a software update for a technical installation and/or one or more elements of the technical installation on the basis of the update configuration, wherein the update configuration comprises operating specifications that need to be observed by the technical installation and/or by the applicable elements of the technical installation during and/or after the performance of the software update.

In some embodiments, the method comprises further method steps or features in order to implement the functional features of the update server or in order to implement further features of the update server, or the embodiments thereof.

In some embodiments, a variant of the computer program product having program commands for configuring a creating device, in particular a 3D printer, a computer system or a production machine suitable for creating processors and/or devices is claimed, wherein the creating device is configured by means of the program commands in such a way that said update server and/or the configuration device is created.

In some embodiments, there is a provisioning device for storing and/or providing the computer program product, wherein
in some embodiments, the computer program product is cryptographically protected,
in some embodiments, the cryptographic protection is a digital signature and/or an encryption of the computer program product and/or is a cryptographic checksum,
in some embodiments, the cryptographic protection may be checked and/or removed by means of the key material of the update server.

The provisioning device may be a data carrier that stores and/or provides the computer program product. In some embodiments, the provisioning device is preferably a network service, a computer system, a server system, in particular a distributed computer system, a cloud-based computer system and/or virtual computer system that stores and/or provides the computer program product in the form of a data stream.

In some embodiments, this provisioning takes place as a download in the form of a program data block and/or command data block, e.g. as a file, in particular as a download file, or as a data stream, in particular as a download data stream, of the full computer program product. However, this provisioning may also take place as a partial download that consists of multiple parts and in particular is downloaded via a peer-to-peer network or provided as a data stream. Such a computer program product is read into a system by using the provisioning device in the form of the data carrier and executes the program commands, with the result that one or more of the methods described herein is carried out on a computer or configures the creating device in such a way that it creates the update server and/or the configuration device.

Elements having the same function are provided with the same reference signs in the figures, unless indicated otherwise. Unless indicated otherwise or already indicated, the exemplary embodiments that follow have at least one processor and/or a storage unit in order to implement or carry out the methods described herein.

Given the large number of different implementation options, it is impossible and also not expedient or necessary for the understanding of the teachings herein to specify all of these implementation options. In this respect, all of the exemplary embodiments that follow are merely intended to illustrate some ways in which, in particular, such implementations of the teaching could manifest themselves.

Consequently, in particular the features of the individual exemplary embodiments are not limited to the respective exemplary embodiment, but relate in particular to the teachings in general. Accordingly, features of one exemplary embodiment may also serve as features for another exemplary embodiment, in particular without this having to be explicitly specified in the respective exemplary embodiment.

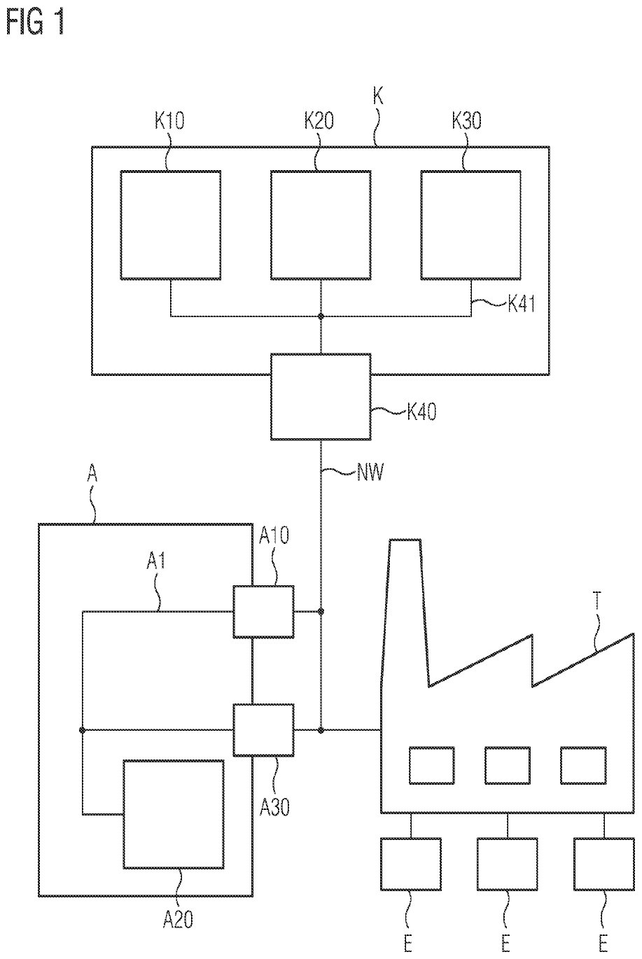

FIG. 1 shows a system comprising a configuration device K, an update server A and a technical installation T, which are communicatively connected to one another via a communication network NW. In variants, the configuration device K and the update server A may be in the form of an update system that comprises the configuration device K and the update server A.

The technical installation T (in particular a production installation, a factory or a production line in a factory) comprises one or more elements E (hardware, such as devices, and/or software).

The configuration device K is configured to determine an update configuration for a software update for the technical installation T.

The configuration device K comprises an acquisition module K10, an optional assessment module, a loading module K20, a determination module K30 and a provisioning module K40, which are communicatively connected to one another via a bus Kl. Moreover, the configuration device K may comprise a processor.

The acquisition module K10 is configured to acquire operating parameters of a production process of a technical installation T, the operating parameters comprising configuration parameters of the one element E or the multiple elements E of the technical installation T or of the technical installation T itself.

The assessment module is configured for example to assess the operating parameters of the production process of the technical installation T, the operating parameters comprising the assessment of the assessment module, for example. To this end, the result is stored as a dataset and appended to or stored in the already acquired operating parameters.

The loading module K20 is configured to load software updates (e.g. firmware, software) for the one or more elements E (e.g. devices of the installation, software components on the installation devices, firmware for devices) of the technical installation T.

The determination module K30 is configured to take the operating parameters and the software updates as a basis for determining an update configuration for the software updates of the one or more elements of the technical installation, the determination module K30 being configured for example to optimize the update configuration on the basis of the operating parameters and the software updates of the one or more elements E of the technical installation T.

The provisioning module K40 is configured to transfer the update configuration and/or the software updates to an update server, the update server controlling and/or monitoring and/or recording the software update of the one or more elements of the technical installation on the basis of the update configuration. The provisioning module may e.g. also scan predefined servers, e.g. of manufacturers of automation components, for software updates (patches) and obtain the latter therefrom if they are e.g. not yet available in the provisioning module.

By way of example, the update server thus not only controls but also monitors and if necessary intervenes if a difference from the update configuration is found when the software update is performed. The update server e.g. also records what it has done, and thus allows later traceability of patch statuses.

The update server A is configured to control a software update for the technical installation T.

The update server A comprises a receiving module A10, an update control system A20 and a transmitting module A30, which are communicatively connected to one another via the bus A1. Moreover, the update server A may comprise a processor.

The receiving module A10 is configured to receive an update configuration and/or a software update, the update configuration and/or the software update preferably being received from the configuration device K.

The update configuration and/or the software update may e.g. also be received from outside the installation. This preferably takes place in a manner protected from the actual technical installation. These may then e.g. later be installed on the technical installation or executed as part of a software update for the installation.

By way of example, a manufacturer having various technical installations (e.g. production installations) that performs the software update in one installation may then transmit the results to other comparable technical installations. To this end, it may e.g. use the applicable update configuration or recordings of the update configuration, or of the performance of the update configuration.

The update control system A20 is configured to perform a software update for the technical installation T and/or for an element E or multiple elements E of the technical installation T on the basis of the update configuration, the update configuration comprising for example operating specifications that need to be observed by the technical installation and/or by the applicable elements of the technical installation during and/or after the performance of the software update.

The transmitting module A30 is configured to communicate with the technical installation and if necessary is used by the update control system A20 to perform the software update.

Various embodiments of the teachings herein comprise and in particular combines two themes. Firstly, an accurate update configuration (e.g. also referred to as the patch plan) is created. Additionally, an update server A (e.g. also referred to as the patch server) is provided that may be linked to the technical installation T (e.g. an industrial installation) and supports the performance of the planned software update (e.g. also referred to as the (planned) patch or planned patching) according to the update configuration. The update server A accompanies and supports the preparation, performance and recording of the software update (e.g. patch processes) of the technical installation T.

The combination of update configuration and update server A leads to a smart software update process, or smart patch process, that e.g. at a technical and organizational level leads to a significant improvement over methods used today for patching industrial installations. The update configuration is used e.g. to create as accurate a reproduction of the processes and measures needed for the software updates (patches) as possible before patches are installed.

The aim is e.g. to determine effects on the production process before patches are installed and to optimize the patching as far as possible. A further aim is for example to have minimum possible downtimes as a result of patches. The patch plan focuses either on the installation as a whole or on elements E of the technical installation T selectively, the elements E being able to be individual components of the technical installation T or specific, critical installation parts of the technical installation T that consist of multiple components. A further aim is for example for the key performance indicators of the production process to observe minimum values when the update configuration is installed, i.e. even if patches are installed during ongoing operation.

The following data of the technical installation T may be taken into consideration for the update configuration:
the determining of the update configuration takes into consideration an update duration for applicable elements of the technical installation, and/or
the determining of the update configuration takes into consideration a rollback time to a state before the software update of the applicable elements of the technical installation, and/or
the determining of the update configuration checks whether a restart for the applicable elements of the technical installation is necessary or whether a live update for the technical installation is possible, and/or
the determining of the update configuration determines what effects the software update has on the technical installation and/or applicable elements of the technical installation during the software update and/or after the software update, and/or
the determining of the update configuration takes into consideration an expected temperature increase for one or more processors of the technical installation and/or for applicable elements of the technical installation, and/or
the determining of the update configuration takes into consideration the required storage space and the required processor power for the software update, and/or
the determining of the update configuration takes into consideration a software compatibility with the existing software and the software update, and/or
the determining of the update configuration takes into consideration license requirements, and/or
the determining of the update configuration takes into consideration an effect on the technical installation in the event of a software update for multiple elements of the technical installation, and/or
the determining of the update configuration takes into consideration a compatibility between updated and unupdated elements of the technical installation, and/or
the determining of the update configuration takes into consideration whether the software update is performable automatically or a manual intervention is required, and/or
the determining of the update configuration takes into consideration necessary access rights (normal service engineer, user, special support by manufacturer), and/or
the determining of the update configuration takes into consideration whether an automated check on manually performed steps is performable, and/or
the determining of the update configuration takes into consideration whether the software update for an applicable element indicates how said element needs to be installed (e.g. is local installation possible or can this also take place remotely, for example using remote maintenance software), and/or
the determining of the update configuration may involve empirical values from updates performed earlier and may implement said empirical values in the form of improvements.

The performance of the software update may e.g. be simulated in advance by means of the update configuration in order to determine this information. This allows e.g. a service engineer to decide what effects on the technical installation and its elements (e.g. a production installation and the components thereof) can be expected if the software update is performed according to this update configuration.

The simulation may simulate e.g. not only the installation of the software update but also the actual production process. This makes it possible for example to determine the effects on the production and on the goods produced if the patch is performed according to the patch plan. The software update is preferably performed by the update server. The update server performs the patch process according to the previously defined and (simulated) update configuration. By way of example, it is able to compare the effects during the actual performance with the effects determined in the simulation beforehand. To this end, a monitoring module is preferably used.

In the event of a difference, e.g. an alarm may be generated. It is thus possible to react in good time if in reality the patch process cannot be performed as could be expected according to the simulation.

The monitoring module is configured to acquire operating parameters of the technical installation and/or of the applicable elements of the technical installation during the performance of the software update, the monitoring module being configured to determine a check result on the basis of the operating specifications and the operating parameters, and a further performance of the software update being controlled on the basis of the check result.

By way of example, an alarm is triggered and/or the software update is terminated if the operating specifications are exceeded by the operating parameters, the software update being continued if the operating specifications are observed by the operating parameters, for example.

The update server may additionally also comprise one or more of the following components:
processors,
general memory areas,
a security module for filing away secret keys and for performing sensitive operations. The patch server has interfaces for input and output and for communication with the components of the installation.

To store sensitive data (e.g. secret keys, cryptographic keys and/or access data and/or license data), the update server comprises e.g. a key memory, the update server using for example the applicable key material and/or the applicable access data and/or the applicable license data for the software update of the technical installation or of an applicable element of the technical installation.

By way of example, the update server uses the key material in order to digitally sign a recorded history of the software update, the key material and/or the access data and/or the license data preferably being assigned specifically to applicable elements of the technical installation and/or being assigned specifically to applicable parts of the software update of applicable elements.

By way of example, the update server comprises a web interface that allows secure and integral communication with equipment suppliers or with a central company server that e.g. serves multiple company sites.

An interface (e.g. the web interface) to a central company server may be used to exchange e.g. the update configuration and/or the software update and/or experience (e.g. check results from the monitoring module) regarding the performance of the software update across distributed sites. It is thus possible, e.g. in the case of companies having multiple sites, for the experiences to be pooled and used for improvements and updates.

As a basis, the update server has e.g. all the information from the update configuration available. The update server is able to evaluate multiple sources for software updates (e.g. components of suppliers, mechanical engineers). A mechanical engineer is able for example to install his software updates on the update server locally. The license on the update server indicates e.g. which software updates the update server is permitted to obtain. The provider of the software update then e.g. does not itself need to provide the know-how protection.

The update server may e.g. also manage rules concerning which software updates (patches) are permitted to be installed how and when, in particular which updates are permitted to take place automatically and which are permitted to take place only with the consent of an administrator/service engineer.

The update server is able to monitor which patches were performed when and which patches are still due. It is able to control whether or not a reset to an earlier FW version is permitted. For example, it is thus possible to prevent an attacker from being able to use old vulnerabilities for attacks by resetting to an earlier component version.

The update server is able e.g. to support the secure documentation of the patches performed. A private signature key, which for example is filed away in a secure manner in the security module, may be used e.g. to generate a signed value from the patch recordings compressed to form a hash value using a hash method, for example by generating and/or storing an applicable hash value or an applicable signed hash value for the data of the recording of the software update, or patch recording.

The signed hash value may e.g. be stored outside the security module and e.g. later, or if required, checked using a public key matching the private signature key. Proof of installed patches, including date and time, may thus be provided for example in installations in which documentations are mandatory (for example FDA requirements in the pharmaceuticals field).

The integral data thus obtained about the patch state of individual devices may e.g. be used as input values for an asset management system of an installation. An installation operator is thus able to tell at the touch of a button what the patch state of its installation is and at what locations at present or at what future time there is a need for action.

The update server (e.g. patch server) may, e.g. as a result of the connection to applicable individual elements (e.g. components), also be used such that an element/component reports directly to the update server and notifies the latter of when e.g. the best time to install a software update is. In the case of software updates previously identified as uncritical, it is then possible e.g. for the patch to be initiated directly by way of the patch server and installed on the element.

For elements that are updated manually nowadays, e.g. using memory cards, the update server may be involved by needing e.g. to enable manual updating, that is to say for example needing to authorize the manual insertion of the memory card. If the authorization from the update server is not available, patching with the new memory card is denied.

The update server affords considerable advantages in particular in installations having many similar components, which today often need to be served with patches individually, and manually (example: large solar farm). If such an installation is able to automatically install the software updates (patches) with the update server, significant costs and time are saved.

The update configuration recorded in the update server may e.g. be continually updated. In this way, empirical values from software update processes performed may be entered in the form of improved update configurations. The update configuration and the update server ensure that only minimal downtimes arise when software updates (e.g. also called patches) are installed on a technical installation.

For example, parallel installation of patches becomes possible. E.g. action recommendations concerning precisely what needs to be done may be provided. E.g. in certain cases an in-situ acknowledgement may be requested that is recorded, and thus documented, in the patch server.

In the case of low-risk patches, e.g. full automation of the patches may be initiated. It is thus possible e.g. to achieve a kind of self-patching and the installation is always up to date. The patch server may e.g. issue a warning if it is unable to perform the patching.

The patch plan may be performed e.g. by involving service engineers. These may e.g. accompany the whole process, perform it completely independently or become involved for specific steps. As such, for example critical patches could be imperatively accompanied by service engineers. This could be e.g. a specific condition in the update configuration (e.g. also referred to as the patch plan).

The update server could e.g. check and document compliance with this rule. This is accomplished e.g. using the monitoring module. The update configuration and the update server may be made available to the installation operator in the cloud as a convenience application, e.g. via an app. The update server is e.g. located in the customer installation and an edge device in the installation is used to ensure secure, encrypted and integral communication in the cloud.

The app may be used e.g. to conveniently request the present patch status (software update status), or a device may report that it is ready for a new patch to be installed. The update configuration can be viewed and updated via the app. The proposed invention would thus also be able to be conveniently incorporated into cloud- and edge-based scenarios, for example into industrial MindSphere environments.

The update configuration and the update server may e.g. save considerable costs because the installation is down more rarely or not at all and the times for restricted operation may be shortened. By way of example, a drop in the quality of the goods produced may also be prevented or the period of time for the software update may be shortened.

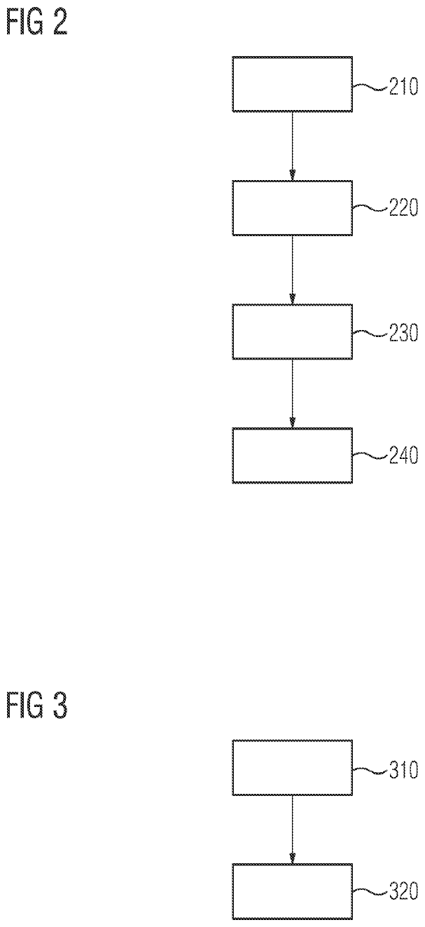

FIG. 2 shows a further exemplary embodiment presented as a flowchart for a method. The method may be implemented on a computer-aided basis. Specifically, this exemplary embodiment shows a method for the computer-aided or computer-implemented method for determining an update configuration for a software update for a technical installation.

The method comprises a method step 210 for acquiring operating parameters of a production process of a technical installation, wherein
the operating parameters comprise configuration parameters of the technical installation,
by way of example, the operating parameters of the production process of the technical installation are assessed by an assessment module,
by way of example, the operating parameters comprise the assessment of the assessment module.

The method comprises a method step 220 for loading a software update for one or more elements of the technical installation.

The method comprises a method step 230 for determining an update configuration on the basis of the operating parameters and the software updates for the software updates of the one or more elements of the technical installation, the update configuration being optimized for example on the basis of the operating parameters and the software updates of the one or more elements of the technical installation.

The method comprises a method step 240 for transferring the update configuration and/or the software update to an update server, the update server controlling and/or monitoring and/or recording the software update of the one or more elements of the technical installation on the basis of the update configuration.

FIG. 3 shows a further exemplary embodiment presented as a flowchart for a method. The method may be implemented on a computer-aided basis. Specifically, this exemplary embodiment shows a method for the computer-aided or computer-implemented control of a software update.

The method comprises a method step 310 for receiving an update configuration and/or a software update, the update configuration and/or the software update being received from a configuration device.

The method comprises a method step 320 for performing a software update for a technical installation and/or one or more elements of the technical installation on the basis of the update configuration, the update configuration comprising for example operating specifications that need to be observed by the technical installation and/or by the applicable elements of the technical installation during and/or after the performance of the software update.

The teachings herein can be used to improve the process of a software update for industrial technical installations. Although the teachings have been illustrated and described more thoroughly in detail by way of the exemplary embodiments, the scope of the disclosure is not limited by the examples disclosed, and other variations may be derived therefrom by a person skilled in the art without departing from the scope of protection of the disclosure.

What is claimed is:

1. A configuration device for determining an update configuration for a software update for a technical installation, the device comprising:
an acquisition module configured to acquire operating parameters of a production process of a technical installation, wherein
the operating parameters comprise configuration parameters of the technical installation;
a loading module configured to load software updates for one or more elements of the technical installation;
a determination module configured to use the operating parameters and the software updates as a basis for determining an update configuration for the software updates of the one or more elements of the technical installation; and
a provisioning module configured to transfer the update configuration and/or the software updates to an update server;
wherein
the update server controls and/or monitors and/or records the software update of the one or more elements of the technical installation on the basis of the update configuration.

2. The configuration device as claimed in claim 1, further comprising an assessment module assessing the operating parameters of the production process of the technical installation;
wherein the operating parameters comprise the assessment of the assessment module;
the determination module is configured to optimize the update configuration on the basis of the operating parameters and the software updates of the one or more elements of the technical installation; and
the determination module is configured to optimize the update configuration on the basis of the operating parameters and the software updates of the one or more elements of the technical installation.

3. The configuration device as claimed in claim 1, wherein:
determining of the update configuration includes determines operating specifications; and
the operating specifications comprise specifications restricting operation of the technical installation during and/or after the performance of the software update.

4. The configuration device as claimed in claim 1, wherein
determining the update configuration depends on:
an update duration for applicable elements of the technical installation; and/or
a rollback time to a state before the software update of the applicable elements of the technical installation, and/or
whether a restart for the applicable elements of the technical installation is necessary or whether a live update for the technical installation is possible; and/or
what effects the software update has on the technical installation and/or applicable elements of the technical installation during the software update and/or after the software update; and/or
an expected temperature increase for one or more processors of the technical installation and/or for applicable elements of the technical installation; and/or
the required storage space and processor power for the software update; and/or
a software compatibility with the existing software and the software update; and/or
license requirements; and/or
an effect on the technical installation in the event of a software update for multiple elements of the technical installation; and/or
a compatibility between updated and unupdated elements of the technical installation; and/or
whether the software update is performable automatically or a manual intervention is required; and/or
necessary access rights; and/or
whether an automated check on manually performed steps is performable; and/or
whether the software update for an applicable element indicates how said element needs to be installed; and/or
empirical values from updates performed earlier and may implement said empirical values in the form of improvements.

5. The configuration device as claimed in claim 1, wherein
performance of the software update of the technical installation is simulated in order to determine the effects of the performance of the software update on the technical installation by way of a simulation.

6. The configuration device as claimed in claim 5, wherein:
the simulation additionally simulates effects of the performance of the software update on the production process and/or
the simulation additionally simulates effects of the software update on the production process.

7. An update server for controlling a software update for a technical installation, the server comprising:
a receiving module configured to receive an update configuration and/or a software update;
an update control system configured to perform a software update for a technical installation and/or an element or for multiple elements of the technical installation on the basis of the update configuration;
wherein the update configuration comprises operating specifications to be observed by the technical installation and/or by the applicable elements of the technical installation during and/or after the performance of the software update.

8. (canceled)

9. The update server as claimed in claim 7, wherein:
the update server comprises a monitoring module configured to acquire operating parameters of the technical installation and/or of the applicable elements of the technical installation during the performance of the software update;
the monitoring module is further configured to determine a check result on the basis of the operating specifications and the operating parameters;
a further performance of the software update is controlled on the basis of the check result;
an alarm is triggered and/or the software update is terminated if the operating specifications are exceeded by the operating parameters; and
the software update is continued if the operating specifications are observed by the operating parameters.

10. The update server as claimed in claim 7, wherein:
the update server comprises a key memory for access data and/or license data and/or key material;
the update server uses the applicable key material and/or the applicable access data and/or the applicable license data for the software update of the technical installation or of an applicable element of the technical installation;
the update server uses the key material in order to digitally sign a recorded history of the software update; and
the key material and/or the access data and/or the license data are assigned specifically to applicable elements of the technical installation and/or are assigned specifically to applicable parts of the software update of applicable elements.

11. The update server as claimed in claim 7, wherein:
the software update comprises one or more package elements for the software update;
applicable package elements are assigned specifically for the software update of applicable elements of the technical installation;
the applicable package elements are provided by different sources; and
the package elements are stored as a bundle in the software update by the update server and/or the configuration device.

12. The update server as claimed in claim 7, wherein the update server comprises an interface for secure communication with the applicable elements of the technical installation.

13. A computer-implemented method for determining an update configuration for a software update for a technical installation, the method comprising:
acquiring operating parameters of a production process of a technical installation, wherein
the operating parameters comprise configuration parameters of the technical installation;
assessing the operating parameters of the production process of the technical installation;
wherein the operating parameters comprise the assessment of an assessment module;
loading a software update for one or more elements of the technical installation;
determining an update configuration on the basis of the operating parameters and the software updates for the software updates of the one or more elements of the technical installation;
wherein
the update configuration is optimized on the basis of the operating parameters and the software updates of the one or more elements of the technical installation;
transferring the update configuration and/or the software update to an update server;
wherein
the update server controls and/or monitors and/or records the software update of the one or more elements of the technical installation on the basis of the update configuration.

14-16. (canceled)
